(19) United States
(12) Patent Application Publication
(10) Pub. No.: US 2014/0279517 A1
(43) Pub. Date: Sep. 18, 2014

(54) Method, A System and a Computer Program Product for Connecting Profiles in Social Networking System

(71) Applicants: Donna Lynne Otzenberger Kivirauma, Kangasala as (FI); Kimmo Kivirauma, Kangasala as (FI)

(72) Inventors: Donna Lynne Otzenberger Kivirauma, Kangasala as (FI); Kimmo Kivirauma, Kangasala as (FI)

(73) Assignee: TeamUp, Oy, Kangalala as (FI)

(21) Appl. No.: 13/832,890

(22) Filed: Mar. 15, 2013

(51) Int. Cl. G06Q 50/00; G06Q 20/10

(52) U.S. Cl. CPC G06Q 50/01; G06Q 20/10
USPC 705/44; 705/39

(57) ABSTRACT

A method, system and a computer program product for connecting a Fan profile to a Business profile in a social networking system. The method comprises at least one Fan profile, at least one Talent profile and at least one Business profile, comprising a computer that has access to the social networking system and is configured to: receive purchasing information of the Business profile purchasing a sponsor item from the Talent profile; and send on behalf of the Talent profile Business information from the Business profile to the Fan profile, where the Fan profile is assigned as a Fan of the Talent profile.

### FIELD OF THE INVENTION

The invention relates to social networking systems. More specifically, the invention relates to connecting profiles in a social network, where Fans, Talents and Businesses have interconnected profiles.

### BACKGROUND OF THE INVENTION

Current social networking systems enable Businesses to communicate with Talents that they are sponsoring or Fans of the Talent. The problem with social media or social networks is that there are currently not sophisticated means to value the effect of a connection between the Business and the Talent or between the Talent and the Fan or the Business and the Fan. Examples of Talents are athletes, artists, musicians, sports clubs or similar entities, looking for sponsorship.

When a brand sponsors a Talent there is currently not a way to know who the people and businesses are that the sponsorship is targeted towards. There is not a way to gain a direct connection to the people and businesses connected to a sponsorship for marketing opportunities. There are no technical solutions available where a Fan can see how their social media sharing, merchandise and event purchases compare with other Fans of a particular Talent or Group.

One known solution is Facebook, where a Talent and a Business can set up a page. These pages are separate and do not work together to provide a marketing opportunity for the business. It also does not address the case for a business-to-business sales relationship. Once a business is able to gain a “like” on their social media page they can post a “status” but there is no guarantee that anyone will see it. The service provider may request a payment to gain extra visibility, but this still offers no guarantee of visibility and who actually is engaging with the “status” post. There is also no way to know, once a “like” is obtained, how influential that person or business is in bringing new likes to the business or talent.

Another problem in social networking systems is that there are too many things competing for space in the user's screen or timeline. As a result the marketing effect is diminished. User's use social networks mostly for personal sharing of information so any advertisements get easily discarded. It is difficult for a Business to tell where Fans come from, for example which Talent or Fan attracted them to their business.

### PURPOSE OF THE INVENTION

The purpose of the invention is to connect social network profiles having different roles. The invention enables the Business to connect with the Fans of the Talent that receives sponsorship from the business.

### SUMMARY

The invention discloses a computer-implemented method for connecting a Fan profile to a Business profile in a social networking system comprising at least one Fan profile, at least one Talent profile and at least one Business profile, comprising a computer that has access to the social networking system. The computer is configured to receive purchasing information of the Business profile purchasing a sponsor item from the Talent profile; and send on behalf of the Talent profile Business information from the Business profile to the Fan profile, where the Fan profile is assigned as a Fan of the Talent profile.

In one embodiment the Talent profile is configured to reject or accept the purchasing of a sponsor item by the Business profile. The social networking system is arranged to display options to the user of the Talent profile. The user may choose to accept only selected sponsors. For example some sponsors may hold values that are contradictory to Talent's own values.

In one embodiment the Business information comprises an invitation for the Fan profile to join the Business Team. In one embodiment the Business information comprises a benefit that is configured to be used in relation to a product or service offered by the Business.

The second aspect of the invention discloses a computer program product for connecting a Fan profile to a Business profile in a social networking system comprising at least one Fan profile, at least one Talent profile and at least one Business profile, residing on a non-transitory processor-readable medium and comprising processor-readable instructions, which, when executed, cause a computer system to receive purchasing information of the Business profile purchasing a sponsor item from the Talent profile; and send on behalf of the Talent profile Business information from the Business profile to the Fan profile, where the Fan profile is assigned as a Fan of the Talent profile.

The third aspect of the invention discloses a social networking system for connecting a Fan profile to a Business profile, comprising at least one Fan profile, at least one Talent profile, at least one Business profile and a computer that has access to the social networking system, comprising at least one processor and memory storing instructions configured to instruct the at least one processor to receive purchasing information of the Business profile purchasing a sponsor item from the Talent profile; and send on behalf of the Talent profile Business information from the Business profile to the Fan profile, where the Fan profile is assigned as a Fan of the Talent profile.

The present invention helps a Talent or a Business to sell merchandise or experiences to Fans. The invention also enhances sponsorship opportunities for Businesses by giving a direct marketing channel to the Fans. A Business Team allows a Business to collect talents and Groups with profiles on a social network to their Business Team through sponsorship. Once the Talent or Group is on a Business Team then the business is able to invite the Fans of the Talent or Group and the other businesses associated with the Talent to be a part of their Business Team. This gives a direct marketing channel for the Business to the Fan of the talent or Group. They can now sell merchandise, experiences and provide special offers directly to the fans or businesses. The invention also takes into account the activities such as attending events, buying items such as CDs, t-shirts, etc.

The Talent or Group's profile is part of the Business Team profile. This enables a coordinated effort to marketing within a community.

The embodiments of the invention described hereinbefore may be used in any combination with each other. Several of the embodiments may be combined together to form a further embodiment of the invention. A method, an apparatus, a computer program or a computer program product to which the invention is related may comprise at least one of the embodiments of the invention described hereinbefore. It is to be understood that any of the above embodiments or modifications can be applied singly or in combination to the respective aspects to which they refer, unless they are explicitly stated as excluding alternatives.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating an exemplary embodiment of the case where the Business starts to sponsor a Talent and the effect of benefits produced to Fans.

### DETAILED DESCRIPTION OF THE INVENTION

Reference will now be made in detail to the exemplary embodiments of the present invention, examples of which are illustrated in the accompanying drawings.

A social network system is an online service, platform, or site that focuses on facilitating the building of social networks or social relations among people who, for example, share interests, activities, backgrounds or real-life connections. The social network or social media comprises users with different roles or profiles. A profile may be considered in different roles in different contexts. According to the present invention, three profile types are introduced: a Fan, a Talent and a Business. At least two Talents form a Group. For this specification, the Fan or Fan profile already present in the social network community system is the first Fan and any new Fan or Fan profile is called the new Fan. This example does not limit the number of Fans in the social network or in the community. The community refers to the social network community system according to the present invention, comprising at least one interconnected Business, Talent and Fan profile. The social network service according to the present invention may comprise several interconnected Business, Talent or Fan profiles. The social network service may comprise a front page configured to be visualized as an Internet web page. The front page may comprise examples of Businesses or Talents and to indicate the reader of the web page some influential Businesses or Talents within the social network service.

The Talent or Group profile is part of the Business Team profile. The Business Team refers to those profiles that are linked to the Business profile or receiving a sponsorship action executed by the Business profile. This enables a coordinated effort to market within a community. The invention takes into account actions and contributions made to a specific Talent or Group by providing a single point to link back to. The Talent or Group creates a profile within the social network community system. The Talent or Group may create a Fan shop as part of the profile to sell items and experiences. The first Fan also creates a profile to the social network community system, assigning to be a Fan of the Talent

In the present social networks a person/Group/business can have many followers/fans/supporters, but limited means to identify the most important ones. The Business who invests in sponsoring the Talent has the same interest as the Fans of the Talent; the present invention utilizes this similar interest on the success of the Talent to open a marketing channel between the Business and the Fan.

When the Business has selected the Talent or Group to their Business Team, all of the Fans of the Talent or Group as well as the Businesses associated with the Talent may receive an invitation from the Talent or Group to join the Business Team with them. The private Fan profile and the Business indicate the Business Team invitation requests. After the Fan or the Business has accepted the request, he will be listed in the profile of the Business Team as being a Team member. The profile is configured to receive special offers from the Business Team and notifications about the Business Team activities.

A user is a person who has created at least one type of profile in the social network service: the Fan profile, the Business profile, or the Talent profile. The user can create multiple profiles in the system, for example the user may have a Fan profile for himself, an administrator profile in a sports team that being a Talent profile, and he may also act as an administrator for his parent's Business profile. One example of the unique identifier for a user, the User_id is the personal email address.

A person who does not have a User_id in the system, is defined as a Visitor. A Visitor can be identified with e.g. web browser cookies.

The Fan profile comprises at least a portion of the following information;
A Fan_id, the unique identifier of a Fan.
A User_id, the link to the user behind the profile.
Name (e.g. “Donna Kivirauma”), with additional information such as a picture, textual description or links to other web sites.
Optional ids of other social media services (e.g. Facebook_id, Twitter_id, Googleplus_id) to receive information such as the number of followers the Fan has, what are his latest tweets, who are his Facebook friends etc.
A list of Talent ids that he is Fan of, e.g. {Talent_id1, Talent_id2}.
A list of Business Teams that he is a member of, e.g. {BT_id1, BT_id2}.
A list of pending invitations to the Business Team, e.g. {(BT_id1, Talent_id1)}, where BT_id1 is the id of the Business Team, and Talent_id1 is the id of the Talent that sent this invitation on behalf of the Business Team. If this list has any items in it, the system can display a reminder in the user interface.

The Talent profile comprises at least a portion of the following information;
A Talent_id, the unique identifier of a Talent.
A User_id, the link to the user behind the profile.
Name of the Talent (e.g. “Masa Orpana”), picture, home town, country, textual description, links to the other web sites.
A video identifier URL, (e.g. to point to a Youtube URL).
Optional ids of other social media services (e.g. Facebook_id, Twitter_id, Googleplus_id) to get information such as how many Likes he has in Facebook, how many followers this Talent has, what are his latest tweets, etc.
A list of Fan ids that are his fans, e.g. {Fan_id1, Fan_id2}.
A list of Talent ids that he is fan of, e.g. {Talent_id1, Talent_id2}. Note: Talent can be a Fan of other Talents as well.
A list of Business ids, that are supporting him, e.g. {Busn_id1, Busn_id2}.
A list of Business Teams that he is a member of, e.g. {BT_id1, BT_id2}.

In one example the Talent profile is associated to a Business shop, comprising items for sale. Items in the shop may have unique_id, picture, description, price (either actual price with or without the VAT, or “ask for pricing”), availability (how many items available/out_of_stock), availability_until_date, and a sponsor_me_to_your_team_flag. The flag titled sponsor_me_to_your_team_flag indicates an item that the Business Team can request to purchase. In effect, the Business or Business Team requests the Talent to join the Business Team and consequently the Business is willing to purchase a sponsoring package. A Business Team can thus request the Talent to join their Business Team, and if the Talent accepts, he will be associated with the Business Team. The Talent may choose to reject the sponsoring offer for any reason, for example the values of the Business not aligning with the values of the Talent. The Talent may also choose only selected number or Businesses from certain business areas, avoiding conflicts between sponsors.

The Business profile comprises at least a portion of the following information;
A Business_id, the unique identifier of a Business.
A User_id, the link to the user behind the profile.
Name of the Business (e.g. “Kilosoft”), picture, textual description, links to their website.
A video identifier URL, (e.g. to point to a Youtube URL) for the company video.
Optional ids of other social media services (e.g. Facebook_id, Twitter_id, Googleplus_id) to get information such as how many Likes the business has in Facebook, how many followers they have, what are their latest tweets, etc.
A list of Talent ids that the business has supported, e.g. {Talent_id1, Talent_id2}.
A list of Business Teams that the business is a member of, e.g. {BT_id1, BT_id2}.
A list of pending invitations to the Business Team, e.g. {(BT_id1, Talent_id1)}, where BT_id1 is the id of the Business Team, and Talent_id1 is the id of the Talent that sent this invitation on behalf of the Business Team. If this list has any items in it, the system can display a reminder in the user interface.

The Business Team profile comprises at least a portion of the following information;
A BT_id, the unique identifier of a Business Team.
A Business_id, linking to the Business profile that this Business Team belongs to.
An Admin_User_id, the link to the user having administrative rights to the Business Team, configured to receive e.g. notifications.
Name of the Business Team (e.g. “Basketball Finland”), picture, textual description, links to their website.
A video identifier URL, (e.g. to point to a Youtube URL) for the Business Team video.
Optional ids of other social media services (e.g. Facebook_id, Twitter_id, Googleplus_id) to get information such as how many Likes the business has in Facebook, how many followers they have, what are their latest tweets, etc.
A list of Talent ids that the Business Team has sponsored to the team, e.g. {Talent_id1, Talent_id2}.
A list of Fan ids that have joined the Business Team and which team-sponsored Talents they are associated with. E.g. {(Fan_id1, Talent_id30), (Fan_id2, Talent_id2, Talent_id3, Talent_id4), (Fan_id3, NULL)}. If the Fan is not fan of any existing team-sponsored talents, then the Talent_id=NULL. This illustrates to the Business Team which Fans are connected to which Talents in the team, and thus the Business Team can have additional marketing operations related to that. For example, the Business Team can send specific messages and information to selected Fans that are indicated as Fans of a Talent.
A list of Business ids that have joined the Business Team, e.g. {Busn_id1, Busn_id2}.
A list of Benefit ids that are available for new members of the team and are configured to be sent together with the invitation message, e.g. {Benefit_id1, Benefit_id2}.

A Benefit_id describes the benefit a Business Team wants to give a new member that will join the team, either directly or via a sponsored Talent. A benefit can be e.g. a coupon (picture), a discount code, etc. Thus, a Benefit_id may consist of a URL to the coupon picture, or it can be just a textual code.

The Business Team profile is configured to access the information of the list of Talent_Invitation_ids illustrating the Talents that this Business Team has requested to join to their team, together with the status of the invitation (pending, accepted, rejected); for example {(Talent_id1, pending), (Talent_id2, accepted), (Talent_id3, rejected)}. The Business Team profile is also configured to access the information of the list illustrating which Fans have received the invitation to join the Team. In one embodiment the list is implemented as a quadruple (Fan_id, Talend_id, status, Benefit_id). The status is either (pending, accepted, rejected). The Talent profile is configured to send an invitation to selected Fans on behalf of the Business Team. Example of the invitation message: {(Fan_id1000, Talent_id1, pending, Benefit_id1), (Fan_id101, Talent_id1, accepted, Benefit_id1), (Fan_id200, Talent_id2, rejected, Benefit_id2)}. The social network service is configured to track that a specific Fan is not sent multiple requests to join the team via e.g. two Talents. However, this feature may also be allowed.

An exemplary embodiment of the invention is illustrated in FIG. 1. In this example the Business Team “BT” expresses interest for joining as a sponsor to a Talent. This is executed for example by a purchase request for item “sponsor me to your team,” arrow 101. The Talent has open items that enable the Business Team to become sponsors easily. The Business Team “BT” goes to Talent A's Business shop and finds an item marked with “Sponsor me to your Team.” This item is a specific item which is marked with the sponsor_me_to_your_business_team_flag. Once the BT tries to purchase the item, or alternatively, if BT clicks the “request” button, the item (Talent_id=A, pending) is added to the List_of_Talent_invitation_ids. The Talent A is notified about this by the system via the user interface or by sending him a specific notification such as an email or SMS.

In arrow 102 the Talent A accepts the purchase request or alternatively he may reject the request. If Talent A accepts the request, the List_of_Talent_invitations_ids is updated: (Talent_id=A, accepted). Otherwise, the status is updated with “rejected.”

Talent A is assigned as a member of the Business Team, arrow 103. Talent A's “list of Business Teams that he is a member of” is added with {BT_id=BT}. Business Team BT's “list of Talent ids that the Business Team has sponsored to the team” is added with {Talent_id=A}. The social network service system is configured to check whether this Talent has Fans who are already members of the Team. They have been introduced to the team for example by some other existing Talent, or they have joined just by pressing the “Join the Team” button on the Business Team BT page. If Fans that are already member are found, the Business Team list “A list of Fan ids that have joined the Business Team and which team-sponsored talents they are associated with” is updated accordingly. For example, Talent_id=A joins Business Team BT. Fan_id=300 is already a member of the BT, and happens to be a Fan of Talent A as well. Thus, this list is updated with the specific item: (Fan_id=300, <existing_talent_ids_if_any>, Talent_id=A). According to this example Talent A is listed as a member of the Business Team BT.

In one embodiment the Business Team has a predefined message to be sent together with benefits for Fans of a new Talent joining the team, arrow 104. The Business Team BT has configured that all Fans of the Talent A will be sent a specific Benefit of discount −50% for next purchase from the associated shop. For example a Benefit_id=1 describing this is selected. The message to be sent may also be edited during this step.

The request to join the Business Team BT is sent to Fans of the Talent. The Talent is the designated sender of the request on behalf of the Business Team, arrow 105. The social network service system generates a message that is sent to all Fans of the Talent A. Talent A may not keep track of these, as the interest for this information is on the Business Team BT. The Business Team's BT list “List that shows, which Fans have received the invitation to join the team” is populated with all fans of the Talent A. Example of the list format: {(Fan_id1, Talent_id=A, pending, Benefit_id=1), (Fan_id2, Talent_id=A, pending, Benefit_id=1), (Fan_id3, Talent_id=A, pending, Benefit_id=1), . . . }. Fan profiles of the Talent A are configured to be added to the list “A list of pending invitations to the Business Team” with (BT_id=BT, Talent_id=A), unless they are already part of the Business Team BT.

Fans of the Talent A, who are not yet a member of the Business Team BT, may receive the message by methods explained in the following. The first example is via the specific messaging system as one-to-one message from the Talent A. In this case the message may be: “Hi <Name of Fan_id1>! I just joined Business Team <Name of BT>. They wanted to say that you are warmly welcome to the team as well. If you join now, you will receive awesome benefits: <contents of the Benefit_id=1>. Click here if you want to join, or visit BT's profile <link>. Best Regards, <Name of Talent_id=A>. Accept/Reject.”. Actions related to Accept/Reject buttons are explained later. The second example is via Fan's personal newsfeed, with similar type of message as above. The third example is via a specific area in the UI of the service, when Fan is logged in, with a similar type of message contents as above. The fourth example is via a specific email to Fan's email address, with a similar type of message contents as above.

All Fans who accept the request will become members of the Business Team and receive benefits, 106. The Fan accepts the invitation either by pressing the Accept button/link, or going to the Business Team BT page and clicking “Join the Team” button. In one embodiment the pending invitation executes following events. The list titled “List that shows, which Fans have received the invitation to join the team” is updated with replacing the information related to Fan_id=1 by (Fan_id1, Talent_id=A, accepted, Benefit_id=1). The Fan receives the Benefit. Depending on the implementation, he may get a specific email to his email address with the contents of the benefit. Or he can be displayed a discount code, etc. The Fan profile's “A list of Business Teams that he is a member of” is added with the Business Team BT. The item (BT_id=BT, Talent_id=A) is removed from Fan profile's list titled “A list of pending invitations to the Business Team.”

The Fan may also reject the invitation by pressing the “Reject” button or link. For a pending invitation, this executes the following events. The list titled “List” that shows, which Fans have received the invitation to join the team” is updated with replacing the information related to Fan_id=1 by (Fan_id1, Talent_id=A, rejected, Benefit_id=1). The system is configured not to remind him about this possibility because the status is not pending, i.e. the “A list of pending invitations to the Business Team” does not contain the Business Team BT any more.

The Fan, Fan_id=3, may also choose to ignore the invitation. In this case, the Fan profile's “A list of pending invitations to the Business Team” remains untouched. This allows the system to remind the Fan about this possibility.

In an embodiment any of the preceding examples may be applied to Business profiles in a similar manner.

The benefits received as a reward for joining the Business Team can be used in the Fan shop. One embodiment provides an Application Programming Interface API, wherein tickets and items may be purchased from Service with API to the social network community system. The ticket and merchandise selling service (the Seller) provides the Talent or the community an ID for an Item they are selling for the Talent in the community. The Talent sets up an Item in the Fan shop for the Item that indicates it will be sold outside of the community. The Talent enters the Item ID provided by the Seller.

The Seller provides to the community system Items sold in its service for community members. The Seller provides a field in the ordering service for the community member to enter the user Id when purchasing the ticket or item. The Seller then provides the community with a list of Fans who have bought tickets from collecting the information from the ordering system. The list first indicates the event or item, then pairs with the Fan ID, e.g. ((Event_ID123, FAN_ID1), (Event_ID123, FAN_ID2) . . . ).

When the community system receives the list from the Seller it triggers the purchase of this item by all of the Fans in the list. The first Fan's profile gains the information of the purchase of the Item. The addition to the profile is handled in a similar manner to how other items purchased from the Talent fan shop are handled. The received benefits may be applied to any shop configuration described herein, also to items, products or services outside the social network community.

In this example the benefit is configured to be used with an event held by the Talent. When a Talent has an event outside of the social network community system, the Fans of the Talent can enter their unique ticket identifier into the community system to receive credit or refund of the price for attending the event. Alternatively, when a Fan purchases an event ticket or merchandise from a service other than the social network community system (e.g. online ticket service such as Lippu.fi) they can give their community user_id at the time of purchase to receive credit in the community for their purchase when the outside service is set-up to send information to the community electronically. Or alternatively, information received via e.g. Foursquare API about Fan's check-in to the event could be counted.

In one example the Talent profile is assigned as the shopkeeper to a Fan shop or to a Business shop, which consists of items for sale. Items in the shop have Shop_item_id, picture, description, price (either actual price with or without the VAT, or “ask for pricing”), availability (how many items available/out_of_stock), availability_until_date. In the case of Business shop, an item can also have a sponsor_me_to_your_team_flag.

Benefit can also be applied to the following examples of a shopping environment. The Talent may have an event to which the tickets are only sold by external merchandise seller such as Lippu.fi. The Fan is rewarded for purchases in the social network community. The Talent sets up a specific item in the Fan shop. In this example the Talent's Fan shop comprises a link to an event seller outside the community. The Talent enters External_item_id code supplied by the outside Event ticket or merchandise seller (Seller) if the event ticket sales or merchandise sales is sent to the social network community via an API. If the process is manual then the social network service generates the Item_ID for manual entry of ticket sales or merchandise sales.

The item information is in one exemplary embodiment entered manually to the social network community system. The Talent receives from the Seller the ticket id range sold, e.g. 1-1000 or a list of ticket id's sold if the ticket id's are not sequential. Similarly, merchandise id codes may be received from the merchandise seller.

The social network community system creates a list of Items sold and the identities of Fans that have bought the Item and this initially assigns a “null” value for the Fan that has bought the Item. The first value is the Item Id that is automatically generated by the social network community system, the second is the Item number supplied by the Seller and the 3rd is the fan who bought the Item e.g. ((ITEM_ID267, ITEM_NBR1, NULL), (ITEM_ID267, ITEM_NBR2, NULL) . . . ).

In the graphical representation of the user interface, next to the item in the Talent shop is a clickable button or a link indicating a text, “I purchased this.” When the Fan clicks the button, a field is opened where the Fan can enter the item number related to the purchased item. The item number is verified by comparing it to the list previously generated. If numbers match, the Fan Id replaces the “null” value for that item. The Fan may receive a credit or reimbursement corresponding to the benefit received by joining the Business Team.

Embodiments of the present invention may be implemented in software, hardware, application logic or a combination of software, hardware and application logic. In an example embodiment, the application logic, software or instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

If desired, the different functions discussed herein may be performed in a different order and/or concurrently with each other.

Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims.

It is obvious to a person skilled in the art that with the advancement of technology, the basic idea of the invention may be implemented in various ways. The invention and its embodiments are thus not limited to the examples described above; instead they may vary within the scope of the claims.

1. A method for connecting a Fan profile to a Business profile in a social networking system comprising at least one Fan profile, at least one Talent profile and at least one Business profile, comprising a computer that has access to the social networking system and is configured to;
receive purchasing information of the Business profile purchasing a sponsor item from the Talent profile; and
send on behalf of the Talent profile Business information from the Business profile to the Fan profile, where the Fan profile is assigned as a Fan of the Talent profile.

2. The method according to claim 1, wherein the Talent profile is configured to reject or accept the purchasing of a sponsor item by the Business profile.

3. The method according to claim 1, wherein the Business information comprises an invitation for the Fan profile to join the Business Team.

4. The method according to claim 1, wherein the Business information comprises a benefit that is configured to be used in relation to a product or service offered by the Business.

5. A computer program product for connecting a Fan profile to a Business profile in a social networking system comprising at least one Fan profile, at least one Talent profile and at least one Business profile, residing on a non-transitory processor-readable medium and comprising processor-readable instructions, which, when executed, cause a computer system to;
receive purchasing information of the Business profile purchasing a sponsor item from the Talent profile; and
send on behalf of the Talent profile Business information from the Business profile to the Fan profile, where the Fan profile is assigned as a Fan of the Talent profile.

6. The computer program product according to claim 5, wherein the Talent profile is configured to reject or accept the purchasing of a sponsor item by the Business profile.

7. The computer program product according to claim 5, wherein the Business information comprises an invitation for the Fan profile to join the Business Team.

8. The computer program product according to claim 5, wherein the Business information comprises a benefit that is configured to be used in relation to a product or service offered by the Business.

9. A social networking system for connecting a Fan profile to a Business profile, comprising at least one Fan profile, at least one Talent profile, at least one Business profile and a computer that has access to the social networking system, comprising at least one processor and memory storing instructions configured to instruct the at least one processor to;
receive purchasing information of the Business profile purchasing a sponsor item from the Talent profile; and
send on behalf of the Talent profile Business information from the Business profile to the Fan profile, where the Fan profile is assigned as a Fan of the Talent profile.

10. The system according to claim 9, wherein the Talent profile is configured to reject or accept the purchasing of a sponsor item by the Business profile.

11. The system according to claim 9, wherein the Business information comprises an invitation for the Fan profile to join the Business Team.

12. The system according to claim 9, wherein the Business information comprises a benefit that is configured to be used in relation to a product or service offered by the Business.
